(19) United States
(12) Patent Application Publication
(10) Pub. No.: US 2012/0210358 A1
(43) Pub. Date: Aug. 16, 2012

(54) SOURCE-INDEPENDENT CONTENT RATING SYSTEM AND METHOD

(75) Inventors: Shemimon Manalikudy Anthru, Dayton, NJ (US); Jens Cahnbley, Princeton Junction, NJ (US)

(73) Assignee: Thomson Licensing LLC, Princeton, NJ (US)

(21) Appl. No.: 13/503,730

(22) PCT Filed: Oct. 29, 2009
(86) PCT No.: PCT/US2009/005867

§ 371 Date: Apr. 24, 2012

(51) Int. Cl. H04N 21/431

(52) U.S. Cl. 725/40

(57) ABSTRACT

A source-independent content rating system and method are provided. The system includes an electronic program guide extractor for extracting program guide information relating to at least one of, programs and channels, from multiple content subscription services. A filter generates identifying information that identifies at least one of a content and a category of the content based on the received program guide information. A subscription manager receives user specified ratings and the identifying information, and manages user interface information displayed to a user. The user interface information includes at least one of the content and the category identified by the identifying information and further includes a user specified rating there for. The subscription manager migrates any user specified ratings provided with respect to a particular one of the multiple content subscription services to all other relevant ones of the multiple content subscription services.

### TECHNICAL FIELD

The present principles relate generally to content rating systems and, more particularly, to a source-independent content rating system and method.

### BACKGROUND

There are many content subscription services available today. Conventional cable television service and satellite television service are examples of content subscription services. All of these services come with a TV guide that helps the user in selecting his preferred content/program. In some cases, the guide also allows the user to type some keyword or category and find the best matching program. These searches with a remote control interface are cumbersome and typically do not provide consistent results with respect to user preferences most of the time. There are other content distribution services such as, for example, NETFLIX, which allow the user to express his/her interest and preference and those ratings are taken in to consideration for the selection of content delivered to that user. However, such services do not allow the transfer of user preferences to or from other content subscription services that are destined to the same user.

### SUMMARY

These and other drawbacks and disadvantages of the prior art are addressed by the present principles, which are directed to a source-independent content rating system and method.

According to an aspect of the present principles, there is provided a source-independent content rating system. The system includes an electronic program guide extractor for extracting program guide information relating to at least one of, one or more programs and one or more channels, from multiple content subscription services. The system further includes a filter, coupled to the electronic program guide extractor, for generating identifying information that identifies at least one of a content and a category of the content based on the received program guide information. The system also includes a subscription manager, coupled to the filter, for receiving user specified ratings and the identifying information, and for managing user interface information displayed to a user. The user interface information includes at least one of the content and the category identified by the identifying information and further includes a user specified rating there for. The subscription manager migrates any user specified ratings provided with respect to a particular one of the multiple content subscription services to other relevant ones of the multiple content subscription services for which such user specified ratings apply so as to display on the user interface the user specified ratings with respect to all of the multiple content subscription services for which the user specified ratings apply.

According to another aspect of the present principles, there is provided, in a set top box or a stand-alone device independent of a set top box or a device working in conjunction with a set top box, a source-independent content rating method. The method includes determining content from a subscription service that a user is viewing, has viewed and/or desires to view, obtaining the user's rating of the content and disseminating the user's rating to other subscription services. This can include extracting program guide information relating to at least one of, one or more programs and one or more channels, from multiple content subscription services. Identifying information is generated that identifies at least one of a content and a category of the content based on the program guide information. User specified ratings are received. User interface information displayed to a user is managed. The user interface information includes at least one of the content and the category identified by the identifying information and further includes a user specified rating there for. Any user specified ratings provided with respect to a particular one of the multiple content subscription services is migrated to all other relevant ones of the multiple content subscription services for which such user specified ratings apply so as to display on the user interface the user specified ratings with respect to all of the multiple content subscription services for which the user specified ratings apply.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles can be better understood in accordance with the following exemplary figures, in which:

FIG. 1 is a block diagram showing an exemplary environment 100 to which the present principles can be applied, in accordance with an embodiment of the present principles;

FIG. 2 is a block diagram showing an exemplary set top box 110 content rating system 115 in accordance with an embodiment of the present principles; and

FIG. 3 is a flow diagram showing an exemplary method 300 for rating content independent of the source of such content, in accordance with an embodiment of the present principles.

### DETAILED DESCRIPTION

The present principles are directed to a source-independent content rating system and method.

In an embodiment, the present principles provide a complementary use for an Internet enabled set top box, namely for a source-independent content rating system. In an embodiment, the present principles provide a means for a user to rate the content the user is watching (or intended or intends to watch) in such a way that, the user's rating can span over multiple content sources destined to such user. The set top box can also build up the user profile for individuals in the family or for the family as a whole (i.e., considered as a single entity) by constantly monitoring the viewing habits and user interactions on the Internet. In an embodiment, the set top box can have the user profile within it, thus providing attendant advantages as described herein below.

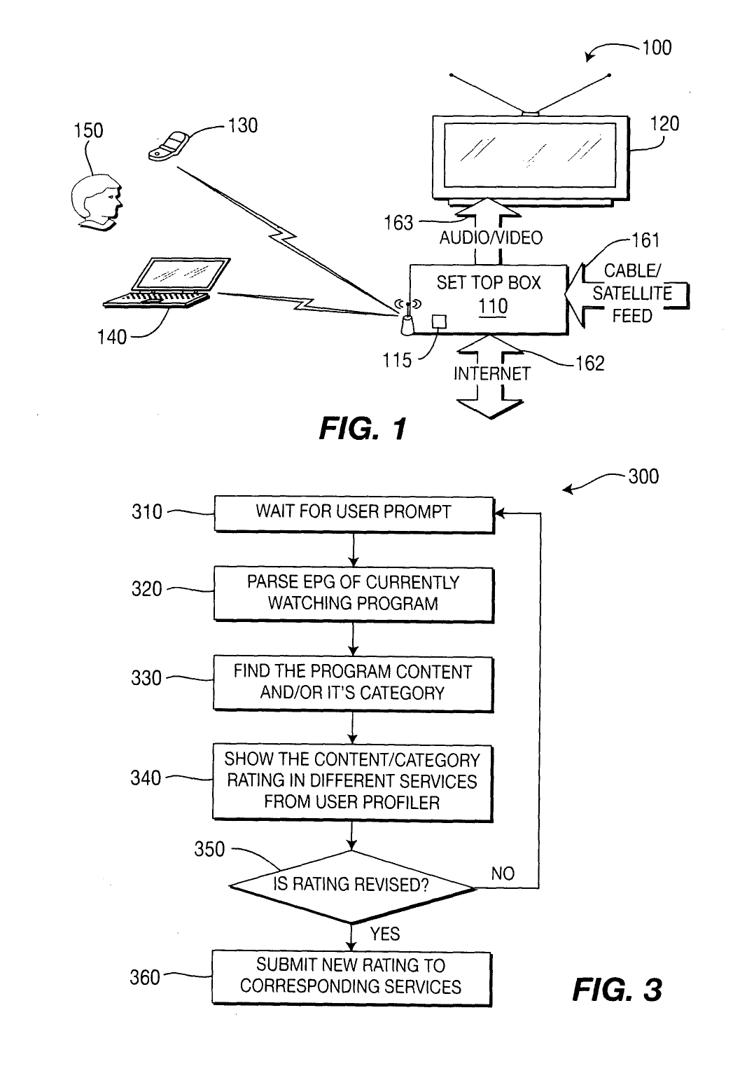

In an embodiment (e.g., such as that shown in FIG. 1), the content rating system can be hosted in a set top box. The content rating system can be implemented as software running (executed) on the set top box, as hardware (for example, using only existing hardware (e.g., processor, memory, etc.), or dedicated hardware) within the set top box, or a combination thereof. Of course, the content rating system can be implemented separately from a set top box as described herein below.

The present description illustrates the present principles. It will thus be appreciated that those skilled in the art will be able to devise various arrangements that, although not explicitly described or shown herein, embody the present principles and are included within its scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which can be substantially represented in computer readable media and so executed by a computer or processor, whether or not such computer or processor is explicitly shown.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage.

Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as readily apparent by one of ordinary skill in this and related arts, for as many items listed.

According to at least one embodiment, a source-independent software content rating system is provided which enables the user to rate multiple contents from different sources. In a least one embodiment, such a system is implemented with respect to a set top box. With respect to at least one embodiment, an Internet enabled set top box with access to television broadcast (either through, for example, cable or satellite) is presumed. The set top box can access any web based services through the Internet in addition to its capability of conventional audio/video rendering with respect to a television.

In at least one embodiment, a system or method is provided by which an end user can express his personal rating of content or its category and that rating gets migrated to multiple content subscription services destined to the user. Existing solutions only allow the user to rate a specific service or content provided by that particular service.

FIG. 1 shows an exemplary environment 100 to which the present principles can be applied, in accordance with an embodiment of the present principles. The system 100 can include and/or otherwise involve a set top box 110, a television 120, a mobile telephone 130, and a laptop 140 and the like. The set top box 110 includes a source-independent content rating system 115. While the embodiment of FIG. 1 shows the content rating system 115 within the set top box 110, in other embodiments the content rating system 115 can be implemented separately from the set top box such as, for example, as a stand-alone device (e.g., including its own processor, memory, user interface, etc), or as part of another device typically found in the environment in which the content rating system is used.

The television 120 can be considered to relate to a primary screen, while the mobile telephone 130 and laptop 140 can be considered to relate to one or more (in this example, two) secondary screens that are synchronized (synced) with the primary screen. As used herein, synchronized refers to being able to view at least some of the same (or related) information, data, and/or media on the primary and secondary screens. In most cases, synchronization will involve such information, data, and/or media being displayed on the primary and secondary screens in a somewhat contemporaneous timeframe with respect to each other (for example, at the same time, or in the case when the user is viewing something on the primary screen then the corresponding information for the secondary screen can be displayed therein at the next time the device that incorporates the secondary screen is activated. For example, in an embodiment, at least the user interface information described below is capable of being displayed on both the primary and secondary screens. In another embodiment, at least the user interface information and the actual content referred to by the user interface information is capable of being displayed on both the primary and secondary screens. Moreover, the television 120, the mobile telephone 130, and the laptop are associated with a particular (i.e., the same) user 150.

A cable and/or satellite feed and the like (also interchangeably referred to herein as “media pipe”) 161 (the former involving at least wired communication means, the latter involving at least wireless communication means) provides video and/or audio content to the set top box 110. A WAN (wide-area network) feed such as, for example, an Internet feed (also interchangeably referred to herein as “data pipe”) 162 (which can involve wired or wireless communication means) can also provide audio and/or video content to the set top box 110. The set top box 110 provides video and/or audio content to the television via a video/audio feed 163 (which can involve wired or wireless communication means). As the present principles are not limited to any particular wired or wireless communication means, with such communication means readily known to those of ordinary skill in this and related arts, any further elaboration of the same is omitted herein for the sake of brevity.

While the particular embodiment shown in FIG. 1 with respect to the secondary screens includes mobile telephone 130 and laptop 140, it is to be appreciated that the present principles are not limited to the preceding devices and, thus, other devices having a screen (e.g., Internet tablets, computers, personal digital assistants (PDAs), media players, etc.) can also be used. Similarly, while one or more embodiments are described herein with respect to content rating relating to a screen(s) and, hence, video data (with a presumption that the same also applies to the corresponding audio data), the present principles can also be applied solely to video data, audio data, or a combination thereof.

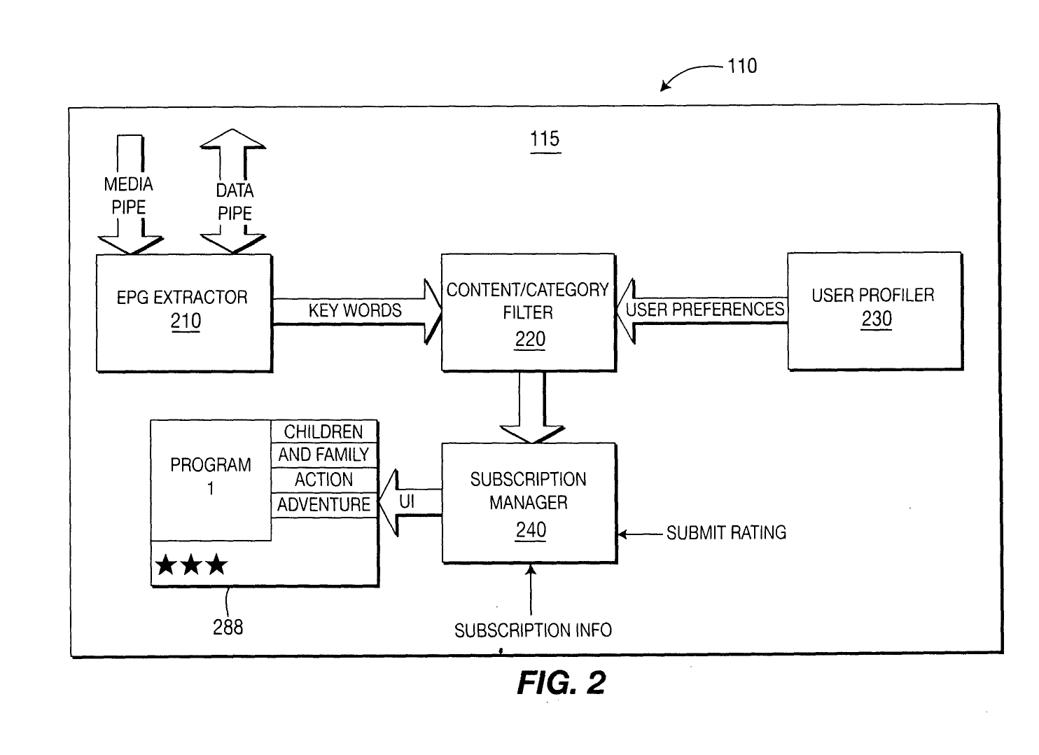

FIG. 2 shows an exemplary set top box 110 content rating system 115 in accordance with an embodiment of the present principles. For example, FIG. 2 can be considered to show the set top box 110 of FIG. 1 in further detail, or can be considered to show a standalone content rating system such as content rating system 115 should such system be implemented separate from the set top box 110. Of course, the content rating system (and attendant elements thereof) can also be implemented in another device.

The set top box 110 content rating system 115 includes an electronic program guide (EPG) extractor 210, a content/category filter 220, a user profiler 230, and a subscription manager 240.

The EPG extractor 210 extracts program guide information of any channel/program coming through the media pipe or data pipe. An Internet based streaming delivery service (such as, for example, NETFLIX streaming to a television) is an example where the television content is subscribed through the Internet. The EPG extractor 210 provides the keywords which better describe the program to the category filter.

The content/category filter 220 identifies the particular content or the category of the content and forwards that information to the subscription manager in addition to the existing user preference on that particular category that the content/category filter 220 receives from the user profiler 230.

The user profiler 230 receives and manages user profile information for one or more users. For example, individuals in a family can be considered separate users and/or the family as a whole being considered as a particular user. The user profile information can include, but is not limited to, for example, the user's favorite contents, recently watched content, mostly watched content within a current or past time range, a preference set by the user (e.g., “I like wild life documentary more than movies”), and so forth. Having this information provided by the user profiler 230, the category/content filter 220 can optimize its suggestions by choosing the best match from a set of possible suggestions. The selection made by the content/category filter 220 is given to the subscription manager 240. The user profile can be for one single “family user” corresponding to the whole family (as one entity) or the user profiler 230 can accommodate multiple users with different logins within the same family. In the latter case, each user can login to the set top box in order to get his profile activated. The “family user” can be the default login for example.

The subscription manager 240 has all of the content subscription service information (destined to the user) and the communication channel information (destined for the content subscription service providers) such as, for example, the details and information necessary to access a NETFLIX account of the user. The content subscription service information can include, for example, a username, password, application ID, and so forth. Thus, in order to access the content subscription of the user, the subscription manager 240 can require the username and password of the account the user is subscribed to and, in some cases, some services can require an application ID for programmatically accessing the service. Such information, which is fully determined by the subscription service and specific to the user, can be provided to the subscription manager 240.

The communication channel information can include, for example, information to contact a particular subscription service(s). For example, the subscription manager 240 also needs access to the communication channel (for example, the data pipe, in the case of an Internet streaming delivery service) to contact the subscription service. The subscription manager 240 should know the address of the portal of the service to contact, for example if the service is Netflix, it could be the domain name of Netflix.

The subscription manager 240 shows a user interface (UI) 288 either on the primary screen or one or more connected second screens through which the user can see his current rating of that particular content or the category of the content. The subscription manager 240 also allows the user to revise the (user specified) rating for the content or (the user specified) category of the content. This revised rating information is updated by the subscription manager 240 with respect to all relevant content distribution services destined to the user.

In this way a user watching a particular movie such as, for example, “Finding Nemo” on HBO can rate that movie or that category (“Children and Family”) on his NETFLIX account and the user will get a similar content sent to him/her by NETFLIX. This also helps the user to see the user's NETFLIX rating of a category or a particular content while watching the same content from a different source. This means the user can use his/her (or aggregate or expert) rating of that content in NETFLIX for the selection of content/program he would like to watch on the user's primary screen from the user's cable/satellite service.

FIG. 3 shows an exemplary method 300 for rating content independent of the source of such content, in accordance with an embodiment of the present principles. At step 310, the method 300 waits for a user prompt. At step 320, EPG information of currently watched programs is parsed. At step 330, the program content and/or its category is found. At step 340, the content/category rating in different services with respect to the user profile is shown. At step 350, it is determined whether or not the rating is revised (by the user). If so, then the method continues to step 360. Otherwise, the method returns to step 210. At step 360, the new rating is submitted to the corresponding services.

That is, in an embodiment, step 360 involves associating (e.g., sharing) the new rating with other content subscription services to which a user has subscribed. That is, when the same or similar program (or same or similar category) is shown with respect to a completely different content subscription service(s) than an initial content subscription service that the rating was initially submitted for, nonetheless that rating will be applied to the completely different content subscription service(s) for the same or similar program (or same or similar category). In this way, a rating that was submitted with respect to only one content subscription service is migrated to other content subscription services that a user (who submitted the rating) is subscribed to.

Of course, the rating can be applied to a single user, a plurality of individual users, and/or more than one user as a single entity. For example, in the case of more than one user as a single entity, one or more family members, e.g., adults as one group and/or children as another group and/or all family members as yet another group, can each be considered as one user entity. Different embodiments can involve one or more or none of the preceding described groups.

With respect to determining whether content and or categories are the same or similar, any matching technique can be used, such as one based on keywords and/or any other matching criteria as readily determined by one of ordinary skill in this and related arts. Moreover, such matching technique can involve thresholds, probabilities, and/or so forth. That is, the present principles are not limited to any particular matching technique for determining correlation between contents and categories and, thus, any matching techniques can be used to accomplish the same.

These and other features and advantages of the present principles can be readily ascertained by one of ordinary skill in the pertinent art based on the teachings herein. It is to be understood that the teachings of the present principles can be implemented in various forms of hardware, software, firmware, special purpose processors, or combinations thereof.

Most preferably, the teachings of the present principles are implemented as a combination of hardware and software. Moreover, the software can be implemented as an application program tangibly embodied on a program storage unit. The application program can be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform can also include an operating system and microinstruction code. The various processes and functions described herein can be either part of the microinstruction code or part of the application program, or any combination thereof, which can be executed by a CPU. In addition, various other peripheral units can be connected to the computer platform such as an additional data storage unit and a printing unit.

It is to be further understood that, because some of the constituent system components and methods depicted in the accompanying drawings are preferably implemented in software, the actual connections between the system components or the process function blocks can differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications can be effected therein by one of ordinary skill in the pertinent art without departing from the scope of the present principles. All such changes and modifications are intended to be included within the scope of the present principles as set forth in the appended claims.

1. A source-independent content rating system, comprising:
an electronic program guide extractor for extracting program guide information relating to at least one of, one or more programs and one or more channels, from multiple content subscription services;
a filter, coupled to the electronic program guide extractor, for generating identifying information that identifies at least one of a content and a category of the content based on the received program guide information; and
a subscription manager, coupled to the filter, for receiving user specified ratings and identifying information, and for managing user interface information displayed to a user, the user interface information including at least one of a content and a category identified by the identifying information and further includes a user specified rating there for,
wherein said subscription manager migrates user specified ratings provided with respect to a particular one of the multiple content subscription services to other relevant ones of the multiple content subscription services for which such user specified ratings apply so as to display on the user interface the user specified ratings with respect to the multiple content subscription services for which the user specified ratings apply.

2. The system of claim 1, further comprising a user profiler for receiving and managing user profile information for one or more users, wherein said filter is further coupled to said user profiler and generates the identifying information based on the user profile information and the received program guide information.

3. The system of claim 1, wherein said electronic program guide extractor extracts keywords as the program guide information.

4. The system of claim 1, wherein said subscription manager is configured to receive updated user specified ratings and initially specified ratings for at least one of the content, other contents, the category, and other categories.

5. The system of claim 1, wherein said subscription manager is further for managing content subscription service information destined to a user and communication channel information destined for content subscription service providers, the content subscription service information and the communication channel information relating to at least one of the one or more programs and the one or more channels.

6. The system of claim 1, wherein the source-independent content rating system is implemented in a set top box.

7. The system of claim 1, wherein the source-independent content rating system is implemented in a device that is independent of a set top box.

8. The system of claim 1, wherein the user interface is implemented with respect to two or more synchronized screens on two or more respective devices.

9. The system of claim 8, wherein the two or more respective devices comprise a stationary television and a mobile device having a screen.

10. The system of claim 8, wherein the two or more respective devices comprise at least two of a television, a mobile telephone, a laptop, a media player, a personal digital assistant, and an Internet tablet, having at least one screen incorporated therein.

11. The system of claim 1, wherein at least one of the multiple content subscription services is at least one of a streaming content subscription service and a web-based content subscription service.

12. The system of claim 1, wherein the multiple content subscription services comprise at least two of a cable television subscription service, a satellite television subscription service, a streaming content subscription service, and a web-based content subscription service.

13. A source-independent content rating method, comprising the steps of:
determining content from a subscription service that a user is viewing, has viewed and/or desires to view;
obtaining the user's rating of the content; and
disseminating the user's rating to other subscription services.

14. The method of claim 13, further comprising the steps of:
extracting program guide information relating to at least one of, one or more programs and one or more channels, from multiple content subscription services;
generating identifying information that identifies at least one of a content and a category of the content based on the program guide information;
receiving user specified ratings;
managing user interface information displayed to a user, the user interface information including at least one of the content and the category identified by the identifying information and further includes a user specified rating there for; and
migrating user specified ratings provided with respect to a particular one of the multiple content subscription services to other relevant ones of the multiple content subscription services for which such user specified ratings apply so as to display on the user interface the user specified ratings with respect to the multiple content subscription services for which the user specified ratings apply.

15. The method of claim 14, further comprising the steps of receiving and managing user profile information for one or more users, and wherein said generating step generates the identifying information based on the user profile information and the received program guide information.

16. The method of claim 14, wherein said extracting step extracts keywords as the program guide information.

17. The method of claim 14, wherein said step of receiving user specified ratings comprises receiving updated user specified ratings and initially specified ratings for at least one of the content, other contents, the category, and other categories.

18. The method of claim 14, further comprising the step of managing content subscription service information destined to a user and communication channel information destined for content subscription service providers, the content subscription service information and the communication channel information relating to at least one of the one or more programs and the one or more channels.

19. The method of claim 14, wherein at least one of the multiple content subscription services is at least one of a streaming content subscription service and a web-based content subscription service.

20. The method of claim 14, wherein the multiple content subscription services comprise at least two of a cable television subscription service, a satellite television subscription service, a streaming content subscription service, and a web-based content subscription service.
